(19) United States
(12) Patent Application Publication
(10) Pub. No.: US 2012/0091740 A1
(43) Pub. Date: Apr. 19, 2012

(54) LATCHES

(76) Inventor: John Phillip Chevalier, London (GB)

(21) Appl. No.: 13/147,180

(22) PCT Filed: Dec. 10, 2009
(86) PCT No.: PCT/GB09/02858

§ 371 Date: Dec. 20, 2011

(30) Foreign Application Priority Data
Dec. 10, 2008 (GB) 0822529.4

(51) Int. Cl. E05B 65/19

(52) U.S. Cl. 292/226

(57) ABSTRACT

A latch for an automotive closure comprises a claw (2), which is spring-biased towards the semi-latched position, for engaging a striker (15) fixed to the closure, a pawl (4) for latching open the claw (2) and a single electric motor (40) selectively coupled to the pawl to cause it to release the claw to open the latch, in one direction of rotation of the motor, and to claw to move it into the fully latched position, in the opposite direction of the motor.

The present invention relates to latches, particularly automotive latches and more particularly latches for releasably closing the boot or tailgate of an automobile though the latches may also find application with other types of closure or door. The invention is concerned with that type of latch which is moved under power between the latched and unlatched or semi-latched positions. Specifically, the invention relates to latches of the type comprising a claw, which is spring-biased towards an unlatched position, for engaging a striker fixed to a closure, a pawl for latching open the claw and motor drive means for moving the pawl so that it releases the claw and for moving the claw into the latched position. Known latches of this type generally include two separate motors, one for moving the pawl and the other for moving the claw.

There are two principal problems with current latches for power release and power closing of automotive tailgates or boots:

When such a latch is to be closed, the motor connected to drive the claw is operated and drives it through an associated geartrain from the secondary or half latched position to the primary or fully latched position. Complete closure of a tailgate or boot requires compression of the large rubber or elastomeric seals which are commonly used and this requires a considerable amount of power. Rotation of the claw therefore needs to be a controlled and powerful action and the geartrain reduces the speed of the motor and thus increases the applied torque and this results in a reduction in the size, weight and cost of the motor. Worm gears and wheels are traditionally used in the geartrain because they operate smoothly and quietly. However, in the event of power failure partway through power closing, it is a requirement that the latch must remain operable mechanically. This means either that the drive mechanism must be back-driven through the geartrain and motor or that a clutch mechanism must be provided between the claw and the geartrain because a worm gear and wormwheel with an appropriate speed reduction ratio is not generally capable of being back-driven, that is to say rotation of the wormwheel will not generally result in rotation of the worm gear.

For boot and tailgate latches which have both a power release function and a power close function, it is desirable that the speed of actuation for power release is as fast as possible but that the speed of actuation for power closing is both slow and controlled. Slow closing is desirable firstly because if something should get trapped in a closing tailgate or boot, such as a finger or an article of clothing, this gives time to halt the closure process and secondly because rapid closing would require a large and expensive drive motor due to the relatively large amount of work that must be done to compress the rubber or elastomeric seals. It would be desirable to use the same motor for both power release and power close for size, weight and cost reasons but previous attempts to do this have been compromised with the result that the power release is too slow and/or the power close is too fast.

It is the object of the present invention to provide a latch which overcomes the above problems in a manner which is efficient, compact and economical.

In accordance with the present invention there is provided a latch for a closure comprising a claw, which is spring-biased towards an unlatched position, for engaging a striker fixed to the closure, a pawl for latching open the claw, a single electric motor selectively drivingly coupled to the pawl and the claw, whereby rotation of the motor in one direction causes the pawl to move to release the claw to permit it to move to the unlatched position and rotation of the motor in the opposite direction causes the claw to move to a latched position.

Thus in the latch in accordance with the present invention, there is only a single electric motor which can act on the pawl to cause it to release the claw when it is operated in one direction, and can act on the claw to force it into the fully latched position, when it is operated in the other direction. The latch will thus include a control system selectively operable to cause the motor to rotate in one or the other direction. The latch preferably includes an intermediate gear assembly connected to the motor and arranged to act on the pawl when the motor rotates in one direction and on the claw when the motor rotates in the opposite direction.

In the preferred embodiment, the intermediate gear assembly comprises a gear reduction drive operable only in the opposite direction of rotation and the gear ratio between the motor and the pawl differs from that between the motor and the claw by a factor of between 3 and 12, preferably 3 to 9 and more preferably 6 to 7. The fact that the transmission ratio between the motor and the pawl is greater than that between the motor and the claw by a significant factor means that it is possible to use a single simple motor with no complex control system and that the motor may be operated at a single speed in one or other direction. However, the differing transmission ratio will mean that movement of the pawl to release the claw, i.e. to unlatch the latch, will happen very much more rapidly than movement of the claw into the fully latched position. This significantly reduced speed of movement of the claw as compared to that of the pawl is highly advantageous, firstly because it means that whilst power release of the latch will be very rapid, power closure of the latch will be relatively slow and secondly because the reduction in speed during power closure will mean that a greater force is generated and thus that the force sufficient to compress the elastomeric seals which are commonly used around automotive tailgates and the like can be generated from a relatively small motor which can nevertheless act to release the latch very rapidly.

This differential transmission ratio between the motor and the pawl and the motor and the claw may be achieved in a number of different ways but in the preferred embodiment the intermediate gear assembly includes two cams connected to a common shaft and arranged to act on a rotary drive lever which is arranged to contact the pawl and to move it from the latched to the released position, when the motor is rotated in one direction, and which is arranged to contact the claw and to move it from the semi-latched to the latched position, when the motor is rotated in the opposite direction, each cam having a cam surface which engages a respective engagement surface on the drive lever, the two pairs of engaging surfaces being positioned and shaped such that the ratio of the speed of rotation of the common shaft to the speed of rotation of the drive lever, when the motor rotates in the one direction, is 3 to 12 times greater than the ratio of the speed of the rotation of the common shaft to the speed of rotation of the drive lever, when the motor rotates in the opposite direction. Accordingly, the use of two such cams connected to a common shaft enables two quite different transmission ratios to be achieved dependent on the direction of rotation of the motor.

The rotary drive lever is preferably arranged to contact the claw at a position which is substantially further from the pivotal axis of the claw than the position at which the claw engages the striker. This difference will result in a mechanical advantage and will serve to further enhance the force applied to the striker and thus also the force applied by the tailgate or the like to the elastomeric or rubber seals around the tailgate so as to compress them during the closure process.

The drive lever is preferably arranged to contact the pawl at a position which is substantially further from the pivotal axis of the pawl than the position at which the pawl engages the claw. This will again produce a mechanical advantage and ensure rapid and reliable release of the claw by the pawl when the motor is operated in the one direction.

It is preferred that the intermediate gear assembly includes a worm gear in mesh with a worm wheel, the worm gear including a helical projection which is inclined to the longitudinal axis of the worm gear by 30 to 45 degrees. This angle of the helical projection or thread on the worm gear will ensure that the worm gear is drivable in reverse and this is not normally the case with conventional worm gear assemblies. However, as explained above, it is important that the intermediate gear assembly is drivable in reverse so that if there should be a power failure during a latching or unlatching operation, that operation may be continued or reversed manually and this will necessitate back-driving of the latch and the intermediate gear assembly by the application of a force to it via the striker and the claw.

It is preferred also that the intermediate gear mechanism includes a kick-start mechanism. Such kick-start mechanisms are known per se and may be of the type disclosed in GB2360333. This kick-start mechanism may have an input connected to the output of the motor and to a flywheel and an output connected to a centrifugal clutch and to the worm gear, the centrifugal clutch being arranged to engage and thus to connect the input and the output of the kick-start mechanism only when the speed of the flywheel has reached a predetermined threshold. This means that when the motor is initially energised, the flywheel will start to rotate relatively slowly and this movement is not initially transmitted to the remainder of the intermediate gear mechanism. However, once the flywheel reaches a predetermined speed, the centrifugal clutch engages and the motor is then connected to the remainder of the intermediate gear mechanism and the connected energy stored in the flywheel will serve rapidly to overcome the inertia of the remaining components of the intermediate gear mechanism and thus rapidly to start them moving. Conversely, however, when operation of the motor ceases, the centrifugal clutch will again disengage. If operation of the motor should cease as a result of a power failure, the disengagement of the centrifugal clutch will mean that if the latch and the intermediate gear assembly are back-driven by the application of a force to the tailgate or the like, this is facilitated by the fact that the motor is disconnected from the intermediate gear assembly and thus need not itself be back-driven.

In practice, the claw is biased by a spring urging it towards its unlatched position and the pawl is biased by a spring urging it towards the position in which it engages the claw. It is preferred that the rotary drive lever is also associated with a spring arranged to return it to a neutral position after the motor has been operated in either direction. It is preferred also that the intermediate gear assembly includes a rotatable final drive gear wheel which is connected to the common shaft and to a spring arranged to return the gear wheel to a neutral position immediately after terminating the supply of electrical power to the motor when it has been driven in the opposite direction.

Thus the latch in accordance with the present invention overcomes the compromises which are currently made in such power driven latches and provides a combination of fast release and slow controlled closure using the same motor. It does so in a very cost-effective manner in that no expensive or sophisticated motor control electronics are necessary because the motor may be operated at constant speed in either one direction or the other. Furthermore, no complex dedicated separate gear mechanisms are required for power release and power closing. The latch may be fully compatible with conventional motor control signals as are currently provided by vehicle electronic Body Control Unit (BCU). Relatively inexpensive sensors, such as Reed switches and magnets, are the only elements required to provide control signals. i.e. for sensing the position of the claw in the latched and semi-latched positions, and these enable communication with the control unit for the provision of signals to start and stop the power closing cycle.

Further features and details of the invention will be apparent from the following description, which is given by way of example only with reference to the accompanying drawings, in which:

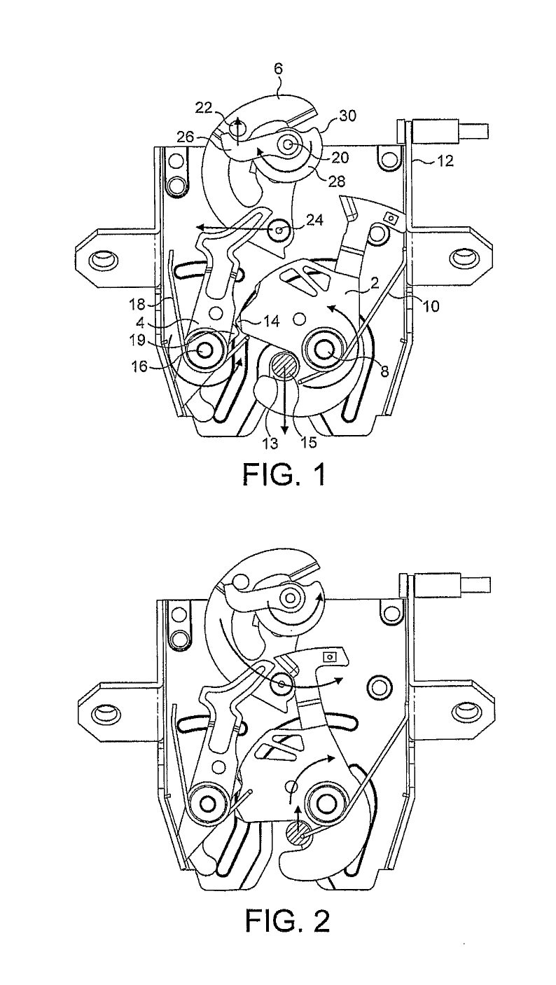

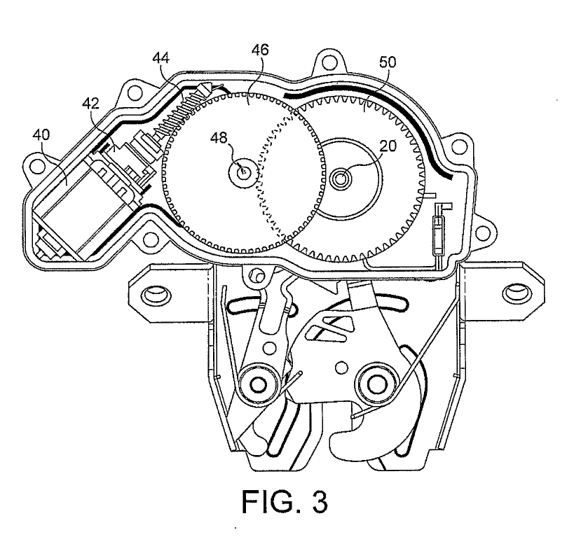

FIGS. 1 and 2 show a latch in the fully latched and semi-latched positions, respectively;

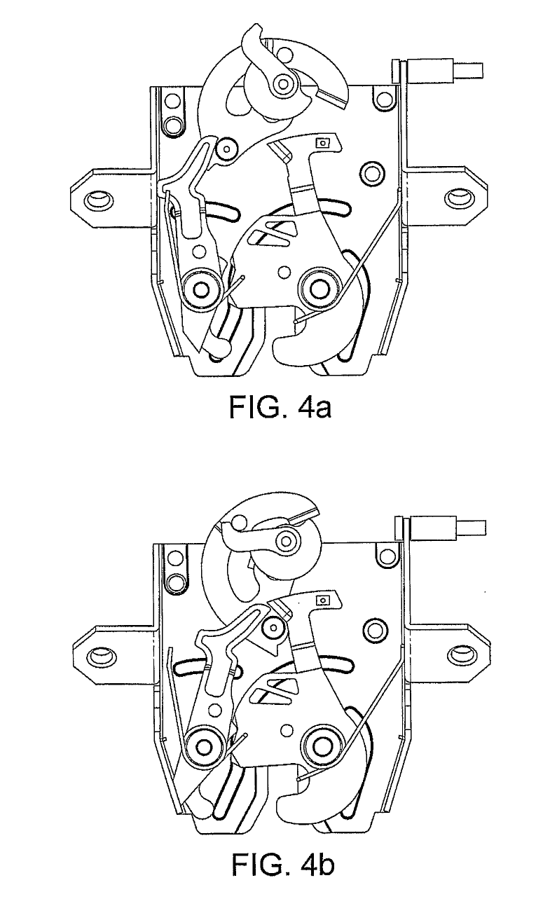

FIG. 3 is a view similar to FIGS. 1 and 2 showing not only the latch but also the electric motor and the associated intermediate gear mechanism;

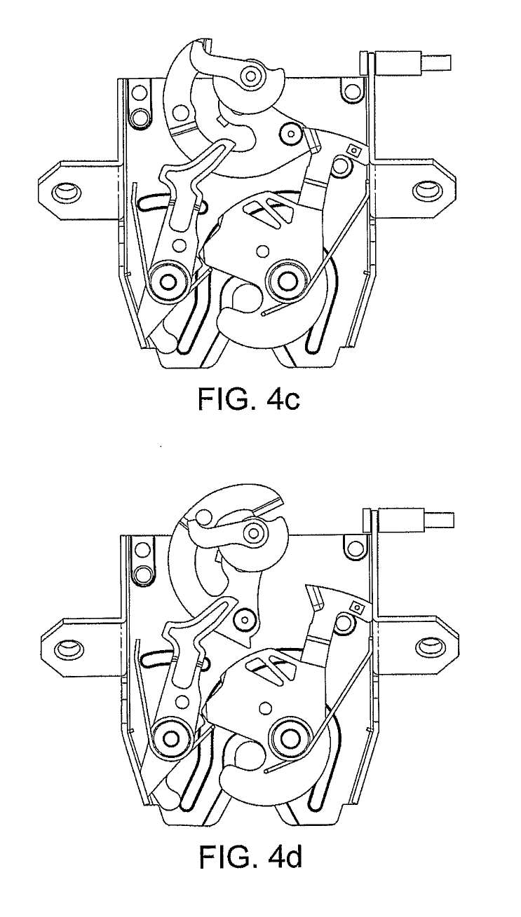

FIGS. 4A to 4D are views similar to FIGS. 1 and 2 showing the latch in various phases of operation;

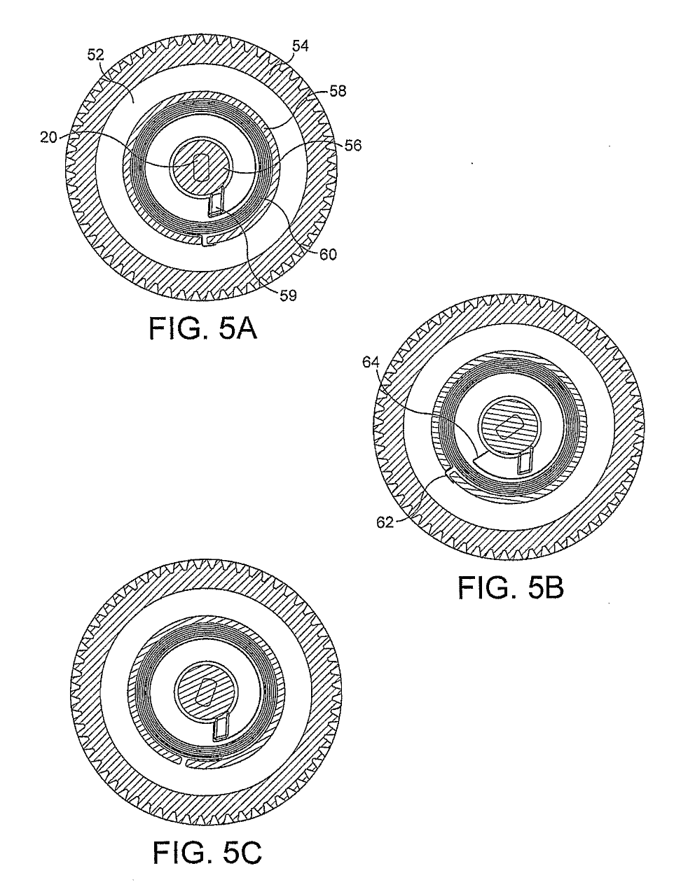

FIGS. 5A, 5B and 5C are sectional views of the final drive gear wheel in the intermediate gear mechanism; and

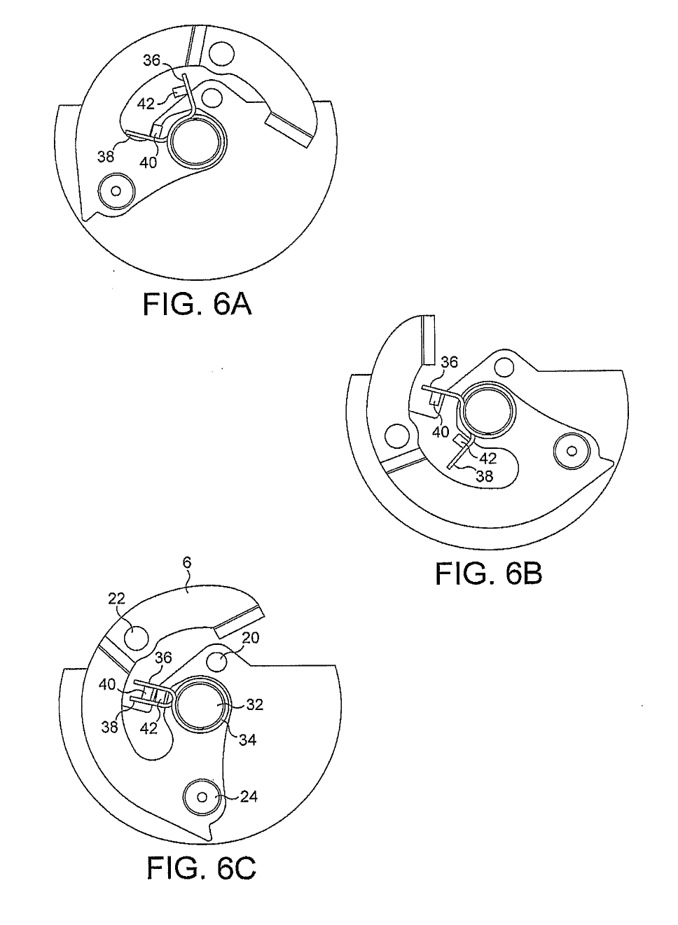

FIGS. 6A, 6B and 6C show the rotary drive lever and its associated return spring.

Referring firstly to FIGS. 1 and 2, the latch comprises a claw 2, a pawl 4 and an arcuate drive lever 6, which may be moved by two cams, as will be described below. The claw 2 is mounted to pivot about a shaft 8. A spring 10 extends around the shaft 8 and has two projecting ends, one of which bears against the latch housing 12 and the other of which is anchored to the caw. The spring 8 biases the claw from the latched position shown in FIG. 1 towards the semi-latched position shown in FIG. 2. The claw defines a latch shoulder 14 on its side surface directed towards the pawl 4. The claw also defines a latch recess 13 which receives and retains a striker 15 connected to the tailgate or other closure which is to be latched.

The pawl 4 comprises an elongate lever which is mounted for pivotal movement about a shaft 16. A spring 18 is wound around the shaft 16 and has two projecting ends, are of which bears against the housing 12 and the other of which is anchored to the pawl. The spring 18 biases the pawl towards the released position shown in FIG. 1. The pawl carries a latching projection 19 which engages the latching shoulder 14 when the latch is in the latched position, i.e. when the closure to which the striker is connected is in the fully closed and latched position. Thus in the latched position shown in FIG. 1 the claw is held in the latched position by engagement of the projection 19 and the shoulder 14 and the closure is held tightly closed.

The drive lever 6 is mounted for pivotal movement about a shaft 20 and carries two upstanding posts 22 and 24. Mounted to rotate with the shaft 20 are two cams 26 and 28, which in this case are made as a single unit. The cam 26 is positioned to contact the post 22 on the lever 6 and the cam 28 affords a curved cam surface 30 positioned to engage the adjacent end surface of the lever 6. The post 24 is positioned to engage the side surfaces of both the pawl and the claw.

If the shaft 20 is rotated in the clockwise direction, the cam rotates clockwise also and contacts the post 22. The lever 6 is the cause to rotate clockwise about the shaft 20 and the post 24 then contacts the upper end of the pawl 4 and causes it to rotate anti-clockwise. Clockwise rotation of the shaft 20 and cam 26 through only about 60° or less is sufficient to move the pawl from the latched to the released position, in which the latching shoulder 14 is no longer engaged by the latch projection 19 and the spring 10 can thus move the claw into the semi-latched position. If the shaft 20 is rotated anti-clockwise, the cam surface 30 on the cam 28 comes into engagement with the end surface of the lever 6 and moves it slowly in the anti-clockwise direction. The profile of the cam surface is such that rotation of the shaft 20 through 300 to 350°, preferably about 330°, is necessary to achieve the desired rotation of the lever 6 sufficiently to move the claw in the clockwise direction, by engagement of the post 24 with the side surface of the claw, from the semi-latched to the latched position. The cam surface therefore acts as a step-down transmission which increases the force applied to the claw, when closing, and means that the closing process is relatively slow by comparison with the opening process. The post 24 is arranged to contact the claw at a position which is preferably between 2 and 4 times further away from the axis of the shaft 8 a the position at which the claw engages the striker, thereby producing a mechanical advantage which assists in the closure of the latch.

The lever 6 is also provided with a spring to return it to a central or neutral position and this is shown in FIGS. 6A, 6B and 6C. The neutral position of the lever is shown in FIG. 6C. Attached to the housing of the latch is a post 32 and wound around this post is a spring 34 with two projecting ends 36 and 38. In the neutral position, both ends 36 and 38 lightly engage the side surfaces of a projection 40 fixed to the housing and a further projection 42 fixed to the lever 6. If the shaft is rotated anti-clockwise, the cam 28 engages the end surface of the lever 6 and rotates it clockwise also, e.g. into the position shown in FIG. 6B. The lever and the projection 42 move clockwise also and the spring arm 38 is also moved by virtue of its contact with the projection 42 whilst the spring arm 36 remains stationary. This stresses the spring 34, which thus exerts a biasing force on the lever 6 to return it to the neutral position. Conversely, if the shaft 20 is rotated clockwise, the cam 26 engages the post 22 and rotates the lever 6 clockwise about the shaft 20 into the position shown in FIG. 6A. The projection 42 thus also moves clockwise and moves the spring arm 36 with it whilst the spring arm 38 remains stationary. This again stresses the spring 34, which again produces a biasing force urging the lever back to the neutral position.

The drive mechanism for the latch will now be described with reference to FIGS. 3, 5A, 5B and 5C. The drive mechanism includes an electric motor which is selectively capable of being driven in either direction. Its output shaft is connected to a “kick-start” mechanism of the type disclosed in GB 2360333. This mechanism includes a centrifugal clutch which only engages when the motor and a flywheel connected to it have reached a predetermined speed. When this speed is reached, the output shaft of the kick-start mechanism is connected to the output shaft of the kick-start mechanism and the momentum of the flywheel ensures that all the elements of the transmission system between the motor and the latch are rapidly accelerated. The output of the kick-start mechanism is connected to a worm gear 44 which, as usual, carries a helical projection or thread. The pitch angle or angle of the projection to the longitudinal axis of the worm gear is between 30° and 45°. The worm gear 44 is in mesh with a worm wheel 46, which is mounted to rotate about a shaft 48. The shaft 48 also carries a small pinion gear (not visible in FIG. 3), which is in mesh with a final drive gearwheel 50, which is connected to rotate with the shaft 20 carrying the cams 26 and 28. Accordingly, the worm gear 44 and worm wheel 46 constitute a first step down stage and the small pinion gear and the gearwheel 50 constitute a further step down stage so a relatively fast speed of the motor 40 will result in very slow rotation of the shaft 20.

The detailed construction of the gearwheel 50 is shown in FIGS. 5A, 5B and 5C. The gearwheel is of generally shallow cup shape with a solid base 52 surrounded by an upstanding peripheral wall 54, whose external surface bears gear teeth. Integral with the base is a coaxial boss 56 with a non-circular hole in it which receives the shaft 20, which is of matching non-circular shape, such that the gearwheel 50 is keyed to rotate with the shaft 20. Projecting laterally from the boss at one circumferential position is a lug or projection 59. Also integral with the base 52 is a coaxial upstanding annular wall 58, which together with the boss defines an annular space. Accommodated within this space is a flat helical spring 60 in the nature of a clock spring with a number of turns. The spring 60 has two free ends 62, 64 which extend in the generally radial direction. The free end 62 is retained in a slot in the wall 58 whilst the free end 64 projects generally radially across the space between the boss 56 and the wall 58.

When the gearwheel is in its normal or neutral position, as shown in FIG. 5A, the lug 59 is immediately adjacent to the free end 64 of the spring. If the motor is actuated in one direction to unlatch the latch, i.e. to move the lever 6 clockwise as seen in FIGS. 1 and 2, the shaft 20 is rotated through about 60° and the lug moves away from the free end 64. When movement of the shaft has ceased as a result of deactivation of the motor and the centrifugal clutch in the kick-start mechanism has disengaged, the spring 34 acting on the lever 6 will restore it to its neutral position. The force of the spring will be transmitted through the post 22 and cam 26 to the shaft 20 and the gearwheel 50 will thus also be restored to its neutral position. Back rotation of the gearwheel 50 will result in back rotation of the gearwheel 46 and also of the worm gear 44. Back-driving of the worm gear by the worm wheel is rendered possible by the steep pitch angle of the helical formation on it and also by the fact that the centrifugal clutch is disengaged which means that the motor does not impede such back rotation. If the motor is activated in the other direction in order to move the claw into the latched position, the gearwheel 50 and shaft 20 rotate in the opposite direction through a much greater angle, as explained above, of typically at least 250° and perhaps as much as 350°. As the shaft 20 rotates, the lug 59 engages the free end 64 of the spring and the spring is wound further or tightened. When rotation has ceased, the spring 34 will act to return the lever 6 to its neutral position but the strength of the spring is not sufficient to return the gearwheel 50 to its neutral position due to the engagement of the lever 6 with the cam surface 30, which acts as a step up gear in this direction. However, the spring 60 acts on the gearwheel 50 and the other gear to which it is connected to return them to their neutral position.

The operation of the latch will now be described with reference primarily to FIGS. 4A to 4D. The latch is shown in the fully latched configuration, in which the striker is firmly retained within the latching recess in the claw and the tailgate or the like is thus firmly closed, in FIG. 4D. The claw is retained in this position by engagement of the latching projection 19 on the pawl with the latching shoulder 14 on the claw. The drive lever 6 is shown in the neutral position. When the tailgate or the like is to be opened, as indicated e.g. by the application of manual pressure to the tailgate release handle, the electric motor is operated in one direction and power is transmitted through the intermediate gear mechanism to drive the shaft 20 in the clockwise direction. The cam 26 engages the post 22 and the drive lever 6 is thus rotated in the clockwise direction also and the post 24 contacts the upper end of the pawl and rotates it in the anti-clockwise direction, thereby permitting the latching projection 19 to move out of engagement with the latching shoulder 14. This is shown in FIG. 4A. The claw spring 10 causes the claw to rotate in the anti-clockwise direction and thus to move into the semi-latched position and this is shown in FIG. 4B. When the latch is again to be latched, the motor is operated in the opposite direction and the shaft 20 is caused to rotate in the anti-clockwise direction.

The cam surface 30 on the cam 28 engages the end surface of the drive lever 6 and causes it to rotate anti-clockwise, though only slowly due to the shape of the cam surface 30. This causes the post 24 on the lever 6 to engage the upper end of the claw and thus progressively to rotate it in the clockwise direction into the fully latched position, as shown in FIG. 4C. In order to release the latch, rotation of the shaft 20 through only, say, 30° to 60° is required whilst in order to move the claw into the fully latched position, rotation of the shaft 20 through 250° to 350° is required, whereby the work done by the motor when latching the latch is very much greater than that done when unlatching it.

1-10. (canceled)

11. A latch for a closure comprising a claw, which is spring-biased towards an unlatched position, for engaging a striker fixed to the closure, a pawl for latching open the claw, a single electric motor selectively drivingly coupled to the pawl and the claw, whereby rotation of the motor in one direction causes the pawl to move to release the claw to permit it to move to the unlatched position and rotation of the motor in the opposite direction causes the claw to move to a latched position, characterised in that an intermediate gear assembly is connected to the motor and arranged to act on the pawl when the motor rotates in one direction and on the claw when the motor rotates in the opposite direction, that the intermediate gear assembly comprises a gear reduction drive operable only in the opposite direction of rotation and two cams connected to a common shaft and arranged to act on a rotary drive lever which is arranged to contact the pawl and to move it from the latched to the released position, when the motor is rotated in one direction, and which is arranged to contact the claw and to move it from a semi-latched position to the latched position, when the motor is rotated in the opposite direction, each cam having a cam surface which engages a respective engagement surface on the drive lever, the two pairs of engaging surfaces being positioned and shaped such that the ratio of the speed of rotation of the common shaft to the speed of rotation of the drive lever, when the motor rotates in the one direction, is 3 to 12 times greater than the ratio of the speed of rotation of the common shaft to the speed of rotation of the drive lever, when the motor rotates in the opposite direction.

12. A latch as claimed in claim 11, in which the rotary drive lever is arranged to contact the claw at a position which is substantially further from the pivotal axis of the claw than the position at which the claw engages the striker.

13. A latch as claimed in claim 12 in which the drive lever is arranged to contact the pawl at a position which is substantially further from the pivotal axis of the pawl than the position at which the pawl engages the claw.

14. A latch as claimed in claim 11 in which the intermediate gear assembly includes a worm gear in mesh with a worm wheel, the worm gear including a helical projection which is included to the longitudinal axis of the worm gear by 30 to 45°.

15. A latch as claimed in claim 14, in which the intermediate gear mechanism includes a kick-start mechanism with an input connected to the output of the motor and to a flywheel and an output connected to a centrifugal clutch and to the worm gear, the centrifugal clutch being arranged to engage and thus to connect the input and the output of the kick-start mechanism only when the speed of the flywheel has reached a predetermined threshold value.

16. A latch as claimed in claim 11 in which the rotary drive lever is associated with a spring arranged to return it to a neutral position after the motor has been operated in either direction.

17. A latch as claimed in claim 11 in which the intermediate gear assembly includes a rotatable final drive gearwheel which is connected to the common shaft and to a spring arranged to return the gearwheel to a neutral position after the motor has been operated in the opposite direction.
